(19) United States
(12) Patent Application Publication
(10) Pub. No.: US 2014/0139394 A1
(43) Pub. Date: May 22, 2014

(54) ULTRA-WIDEBAND ANTENNA HAVING FREQUENCY BAND NOTCH FUNCTION

(71) Applicant: Electronics and Telecommunications Research Institute, Daejeon (KR)

(72) Inventors: Dae-Heon LEE, Daejeon (KR); Hae-Yong YANG, Daejeon (KR); Ui-Jung KIM, Daejeon (KR)

(73) Assignee: Electronics and Telecommunications Research Institute, Daejeon (KR)

(21) Appl. No.: 13/914,712

(22) Filed: Jun. 11, 2013

(30) Foreign Application Priority Data
Nov. 16, 2012 (KR) 10-2012-0130204
Apr. 22, 2013 (KR) 10-2013-0044186

(51) Int. Cl. H01Q 1/50

(52) U.S. Cl. CPC H01Q 1/50
USPC 343/860

(57) ABSTRACT

An ultra-wideband (UWB) antenna having a frequency band notch function is provided. The UWB antenna includes a substrate, a radiation part, a feeding part, and a slot. The radiation part is formed on one surface of the substrate, and radiates radio signals. The feeding part is formed on the other surface of the substrate, and feeds electric signals to the radiation part. The slot is formed in a stub formed at one end of the feeding part, and rejects frequencies in a notch band in the radio signals that are radiated by the radiation part.

### CROSS REFERENCE TO RELATED APPLICATIONS

This application claims the benefit of Korean Patent Application Nos. 10-2012-0130204 and 10-2013-0044186, respectively filed on Nov. 16, 2012 and Apr. 22, 2013, which are hereby incorporated by reference in their entirety into this application.

### BACKGROUND OF THE INVENTION

1. Technical Field

The present invention relates generally to an ultra-wideband (UWB) antenna having a frequency band notch function and, more particularly, to a UWB antenna that has a band stop characteristic in a specific band (for example, a 5.5 GHz band).

2. Description of the Related Art

A UWB system is a wireless system that is capable of high-speed information transmission at hundreds of Mbps over a short distance within 10 m using very low power that does not interfere with the operation of an existing wireless station and a UWB spectrum that is equal to or higher than 500 MHz.

A UWB system is expected to be widely used in the fields of a next generation wireless personal area network (WPAN), such as a home network, and a short-range radar system, thanks to it having the advantages of low power, low cost, and high-speed data transmission.

Meanwhile, the frequency band assigned to a UWB system is a band of 3.1 to 10.6 GHz. This band overlaps the frequency band of an IEEE 802.11a wireless local area network (WLAN) that operates in a band of 5.15 to 5.825 GHz.

Accordingly, in order to overcome the problem of electromagnetic interference (EMI) between the UWB system and the 5 GHz WLAN system, there is a need for a UWB antenna having a frequency band notch function.

As antennas for a UWB system, a Vivaldi antenna, a bow-tie antenna, and a discone antenna are known.

Although U.S. Pat. No. 4,843,403 entitled “Broadband Notch Antenna,” U.S. Pat. No. 5,081,466 entitled “Tapered Notch Antenna,” and U.S. Pat. No. 5,519,408 entitled “Tapered Notch Antenna using Coplanar Waveguide” disclose various types of UWB Vivaldi antennas, these conventional antennas are problematic in that they include no provision for a frequency band notch function.

Furthermore, recently, for UWB antennas having a frequency band notch function, there have been proposed various types of UWB monopole antennas in which a U- or V-shaped slot is formed in a radiating part, thereby rejecting an undesired frequency band.

However, these band-notched UWB monopole antennas having a frequency band notch function have the disadvantage of a spatial-dependent band-stop characteristic because a slot is disposed in a radiating part.

### SUMMARY OF THE INVENTION

Accordingly, the present invention has been made keeping in mind the above problems occurring in the conventional art, and an object of the present invention is to provide a UWB antenna having a frequency band notch function, which can provide omnidirectional gain suppression in the notch band and can be implemented in a simple, small-sized, lightweight form.

In accordance with an aspect of the present invention, there is provided a UWB antenna having a frequency band notch function, including a substrate; a radiation part formed on one surface of the substrate and configured to radiate radio signals; a feeding part formed on the other surface of the substrate and configured to feed electric signals to the radiation part; and a slot formed in a stub formed at one end of the feeding part and configured to reject signals in a notch band in the radio signals that are radiated by the radiation part.

The slot may have a spiral shape.

The slot may have a predetermined length and width.

The center frequency and bandwidth of the notch band may be controlled by adjusting the length and width of the slot.

The center frequency of the notch band may be lowered by increasing the length of the slot.

The bandwidth of the notch band may be decreased by reducing the width of the slot.

The slot may have a length corresponding to ½ of a wavelength of a center notch frequency.

The UWB antenna may have an omnidirectional gain suppression characteristic in the notch band.

The radiation part may have a tapered slot.

In accordance with another aspect of the present invention, there is provided a UWB antenna having a frequency band notch function, including a dielectric substrate; and a spiral shape slot formed at an end of a feeding line formed on one surface of the dielectric substrate opposite a radiation part formed on the other surface of the dielectric substrate, and configured to reject signals in a notch band in the radio signals that are radiated by the radiation part; wherein the slot has a length corresponding to ½ of a wavelength of a center notch frequency.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a bottom view illustrating a UWB antenna having a frequency band notch function according to an embodiment of the present invention;

FIG. 2 is a plan view illustrating the UWB antenna having a frequency band notch function according to the embodiment of the present invention;

FIG. 3 is a diagram illustrating the equivalent circuit of the UWB antenna having a frequency band notch function illustrated in FIGS. 1 and 2;

FIG. 4 is a graph illustrating the voltage standing wave ratios (VSWRs) of the UWB antenna having a frequency band notch function according to the embodiment of the present invention;

FIGS. 5 to 8 are diagrams illustrating the radiation patterns of the UWB antenna having a frequency band notch function according to the embodiment of the present invention;

FIG. 9 is a graph illustrating the gains of the UWB antenna having a frequency band notch function according to the embodiment of the present invention;

FIGS. 10A and 10B are graphs illustrating the impulse response characteristic of the UWB antenna having a frequency band notch function according to the embodiment of the present invention;

FIGS. 11 to 14 are per-frequency current distribution simulation diagrams of the UWB antenna having a frequency band notch function according to the embodiment of the present invention;

FIG. 15 is a graph illustrating the comparisons between voltage standing wave ratios attributable to changes in the length attic spiral slot of the UWB antenna having a frequency band notch function according to the embodiment of the present invention; and

FIG. 16 is a graph illustrating the comparisons between voltage standing wave ratios attributable to changes in the width of the spiral slot of the UWB antenna having a frequency band notch function according to the embodiment of the present invention.

### DESCRIPTION OF THE PREFERRED EMBODIMENTS

A UWB antenna having a frequency band notch function according to an embodiment of the present invention will be described with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

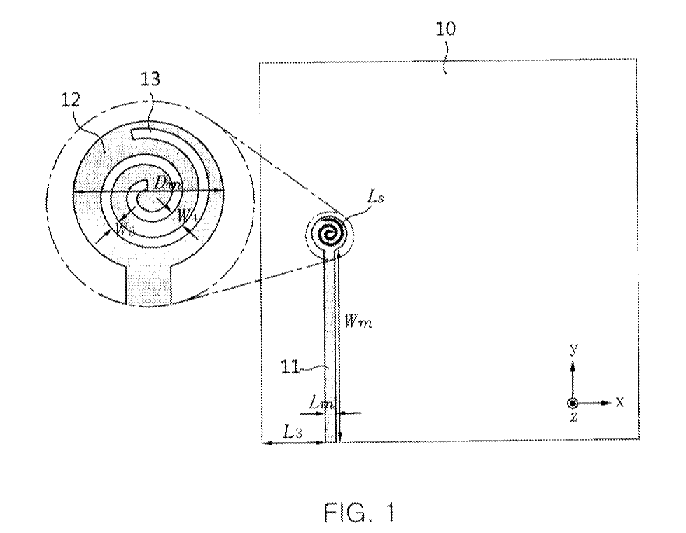

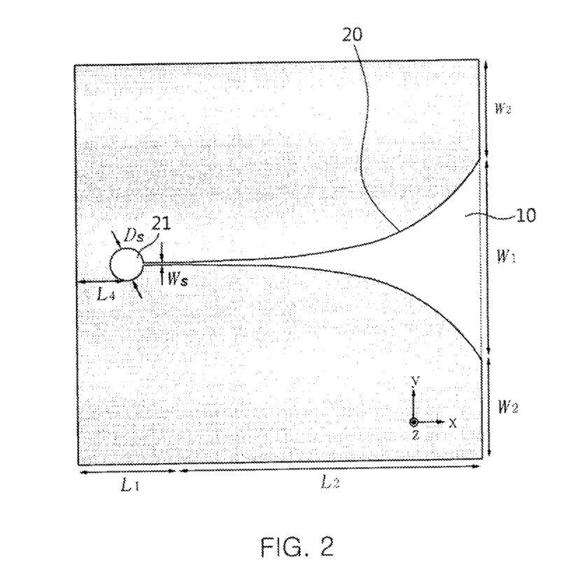

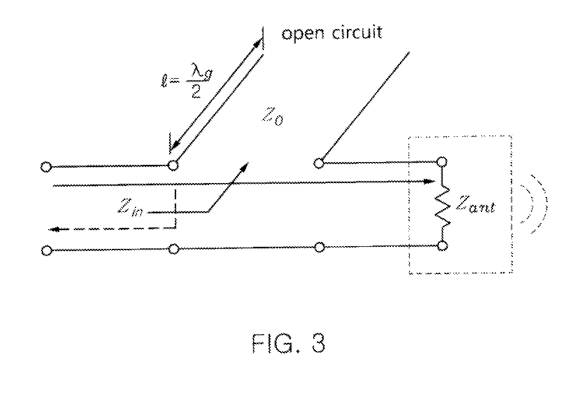

FIG. 1 is a bottom view illustrating a UWB antenna having a frequency band notch function according to an embodiment of the present invention, FIG. 2 is a plan view illustrating the UWB antenna having a frequency band notch function according to the embodiment of the present invention, and FIG. 3 is a diagram illustrating the equivalent circuit of the UWB antenna having a frequency band notch function illustrated in FIGS. 1 and 2.

Although the UWB antenna having a frequency band notch function according to the embodiment of the present invention is similar to a conventional tapered slot antenna (TSA), the UWB antenna having a frequency band notch function according to the embodiment of the present invention is different from the conventional TSA in that a spiral slot 13 is added to a microstrip circular stub 12 in order to provide a frequency band notch function.

As illustrated in FIGS. 1 and 2, the UWB antenna having a frequency band notch function according to the embodiment of the present invention includes a substrate 10, a feeding part 11, a radiation part 20, a microstrip circular stub 12, and a spiral slot 13.

The substrate 10 may be implemented using a dielectric material having a thickness of about 0.8 mm and a relative dielectric constant of 4.4, for example, FR4.

The feeding part 11 is formed on the bottom of the substrate 10, and supplies electric signals. The feeding part 11 is configured in the form of, for example, a microstrip line of about 50Ω.

The radiation part 20 is formed on the top of the substrate 10, and radiates radio signals. The radiation part 20 may be configured in the form of, for example, a horn.

The microstrip circular stub 12 is formed at one end of the feeding part 11.

A slot-line shorted stub 21 is formed in the radiation part 20 at a location about L4 away from one side end of the radiation part 20. The slot-line shorted stub 21 communicates with a narrow slot on one side thereof. Here, for example, the narrow slot is shaped such that the width of thereof is about Ws on the one side of the slot-line shorted stub 21, gradually increases from the side of the slot-line shorted stub 21 up to the opposite side end of the radiation part 20, and is about W1 on the opposite side end of the radiation part 20 (that is, the narrow slot has a shape that is tapered in the form of a horn). The slot-line shorted stub 21 and the narrow slot formed on one side of the slot-line shorted stub 21 may be collectively referred to as a slotline transition part. Furthermore, the microstrip circular stub 12, the slot-line shorted stub 21, and the narrow slot formed on one side of the slot-line shorted stub 21 may be collectively referred to as a microstrip-slotline transition part. The microstrip-slotline transition part connects the feeding part 11 with the radiation part 20.

In this case, since the microstrip circular stub 12 and slotline transition part of the feeding part 11 have a frequency-independent transfer characteristic, a UWB radio signal may be transferred from the feeding part 11 to the radiation part 20.

In particular, in this embodiment of the present invention, in order to notch signals in a 4.6 to 6.2 GHz band, the center frequency of which is about 5.5 GHz, the spiral slot 13 having a predetermined length is formed in the microstrip circular stub 12.

Here, it is preferred that the spiral slot 13 have a length that corresponds to ½ of the wavelength of the center notch frequency. Referring to the equivalent circuit diagram of FIG. 3, Zᵢₙ is the input impedance of the spiral slot 13, Zₒ is the characteristic impedance of the spiral slot 13, l is the length of the spiral slot 13, β is the propagation constant of the spiral slot 13, Zₐₙₜ is the antenna radiation impedance, and λ_{g} is the guide wavelength of the spiral slot 13. The input impedance Zᵢₙ of the spiral slot 13 may be expressed by the following Equation:

Zᵢₙ=−jZₒ cot βl

Accordingly, if the length l of the spiral slot 13 becomes half of the wavelength of the notch frequency (l=λ_{g}/2), the input impedance Zᵢₙ becomes infinite (β=2π/λ_{g}). That is, signals corresponding to the notch frequency are stopped by the spiral slot 13. As a result, in an embodiment of the present invention, it is preferred that the length of the spiral slot 24 be ½ of the wavelength of the center notch frequency.

The spiral slot 13 prevents frequency signals to be blocked from being transferred from the microstrip circular stub 12 to the radiation part 20 while functioning as a resonator.

The dimensions of the parameters illustrated in FIGS. 1 and 2 are illustrated in the following Table 1 by way of example:

TABLE 1

| Parameter | Value (mm) | Parameter | Value (mm) |
|---|---|---|---|
| W₁ | 25.2 | Dₘ | 4.8 |
| W₂ | 12.4 | Dₛ | 4 |
| L₁ | 8.5 | Wₛ | 0.16 |
| L₂ | 41.5 | W₃ | 0.35 |
| Wₘ | 25.11 | W₄ | 0.5 |
| Lₘ | 1.46 | L₃ | 8.22 |
| L₄ | 6.2 | Lₛ | 14.8 |

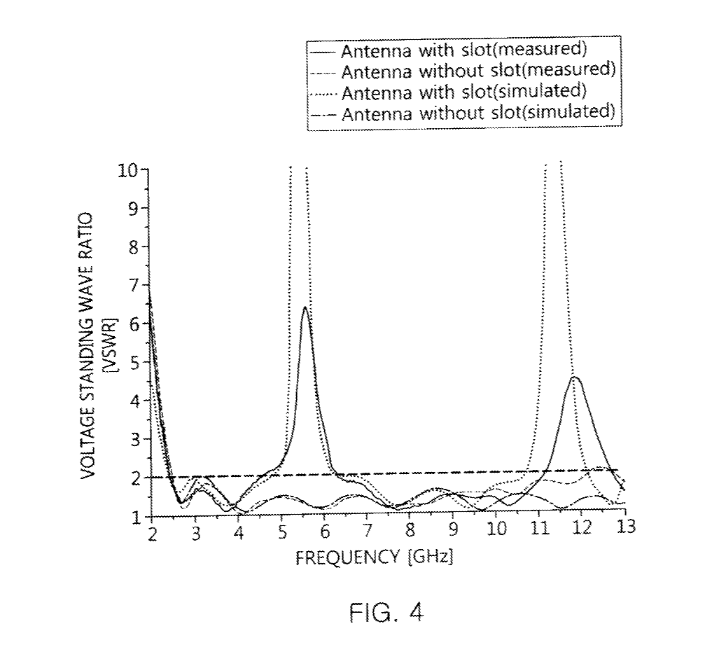

FIG. 4 is a graph illustrating the voltage standing wave ratios (VSWRs) of the UWB antenna having a frequency band notch function according to the embodiment of the present invention.

To compare notch characteristics with each other, the present applicant simulated and measured the VSWRs of a conventional tapered slot antenna (TSA) without the spiral slot 13 and the UWB antenna with the spiral slot 13 according to the embodiment of the present invention.

From the graph, it can be seen that the UWB antenna according to the embodiment of the present invention obtained a notch characteristic in the 4.6 to 6.2 GHz frequency band, unlike the conventional TSA, because the spiral slot 13 was formed in the UWB antenna.

Furthermore, the UWB antenna according to the embodiment of the present invention has an impedance bandwidth of 2.4 to 11.2 GHz for a VSWR less than 2.

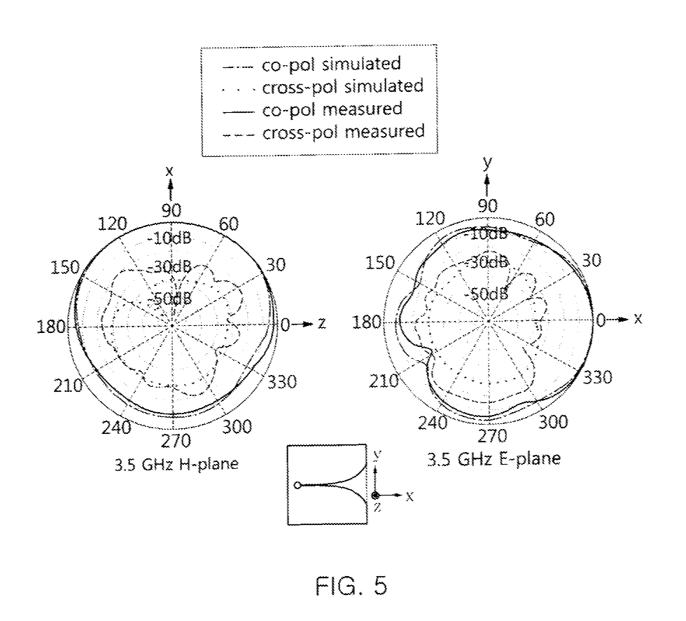

FIGS. 5 to 8 are diagrams illustrating the radiation patterns of the UWB antenna having a frequency band notch function according to the embodiment of the present invention.

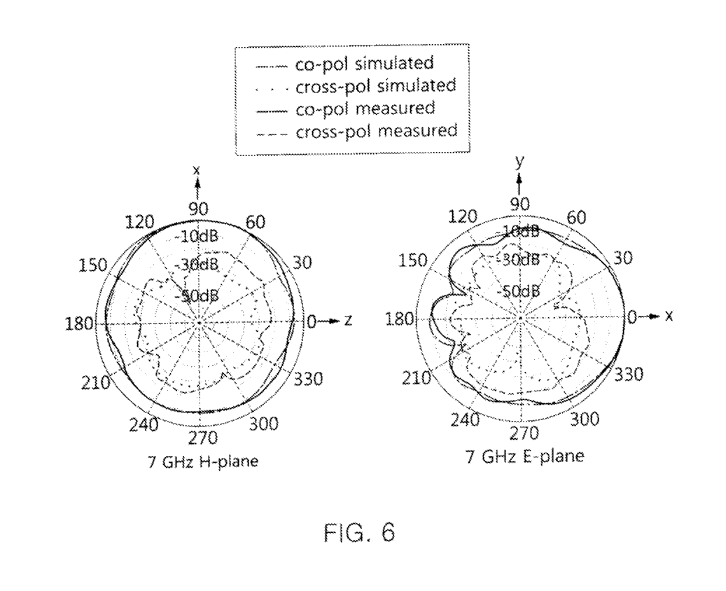

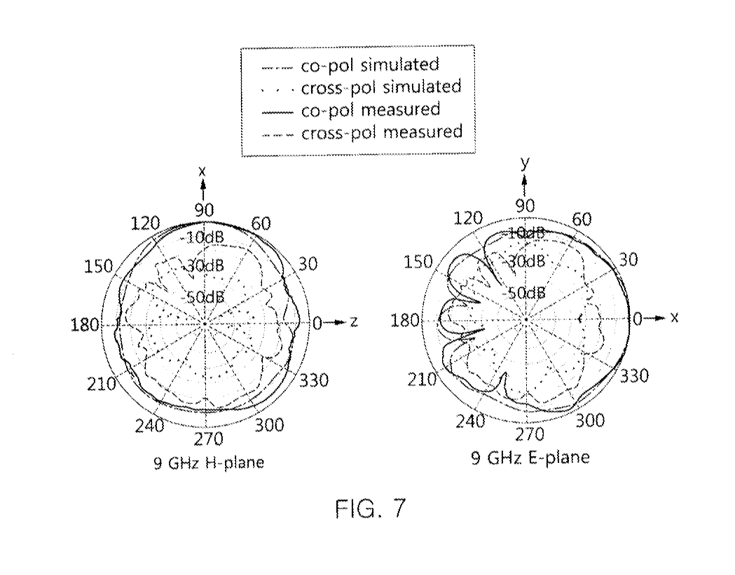

FIG. 5 illustrates the results of the simulation and measurement of far-field radiation patterns at a frequency of 3.5 GHz with respect to a horizontal plane (an x-z plane) and a vertical plane (an x-y plane). FIG. 6 illustrates the results of the simulation and measurement of far-field radiation patterns at a frequency of 7.0 GHz with respect to the horizontal plane (the x-z plane) and the vertical plane (the x-y plane), and FIG. 7 illustrates the results of the simulation and measurement of far-field radiation patterns at a frequency of 9.0 GHz with respect to the horizontal plane (the x-z plane) and the vertical plane (the x-y plane).

In general, in the case of an electromagnetic field that is radiated from an antenna into free space, a reactive electromagnetic field is larger than a radiating electromagnetic field within a specific distance, and this region is referred to as a reactive near-field region. Thereafter, the radiating electromagnetic field gradually increases, and this region is referred to as a radiating near-field region. Here, the radiating near-field region is also referred to as a Fresnel region, and the electromagnetic field present in this region is referred to as a Fresnel field. Radio waves that are radiated from the antenna gradually become similar to plane waves while passing through the Fresnel region. Meanwhile, a region in which the distance R between the antenna and radio waves is longer than 2 L²/λ is referred to as a far-field region or a Fraunhofer region, and the electromagnetic field present in this region is referred to as a fir-field. Here, L is the antenna aperture surface length, and λ is the working wavelength.

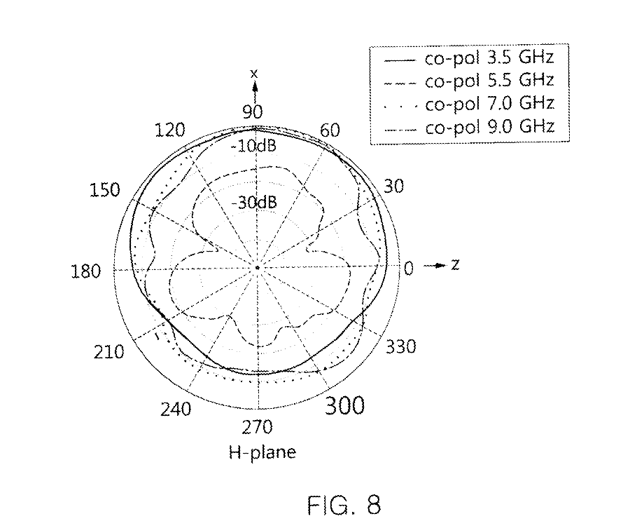

The comparisons between the measured values of the far-field radiation patterns at 3.5 GHz, 7.0 GHz, and 9.0 GHz and the measured values of the far-field radiation pattern at 5.5 GHz are illustrated in FIG. 8.

From FIG. 8, it can be seen that the UWB antenna having a frequency band notch function according to the embodiment of the present invention exhibits the omnidirectional gain suppression in the notch band.

In particular, it can be seen that band-stop is performed in the desired notch band because a radiation pattern at 5.5 GHz, that is, the center notch frequency, exhibits an omnidirectional gain suppression characteristic greater than 10 dB.

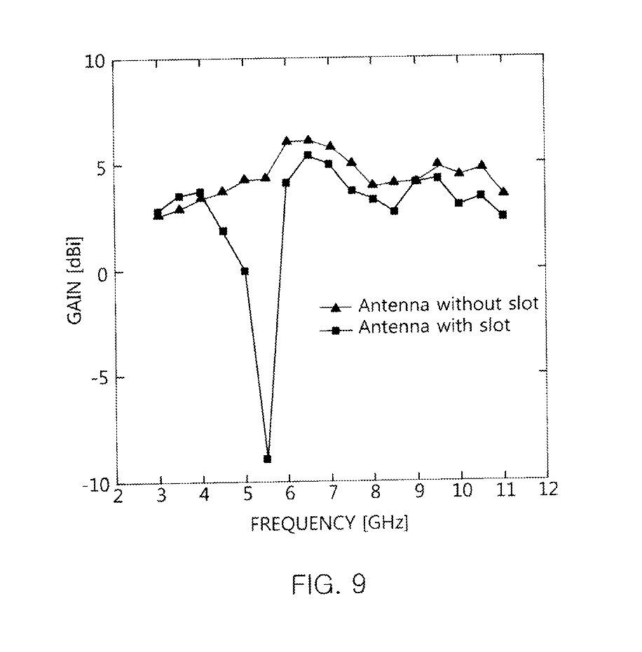

FIG. 9 is a graph illustrating the gains of the UWB antenna having a frequency band notch function according to the embodiment of the present invention.

The present applicant illustrates the results of the comparisons between the measured gains of the conventional TSA antenna without the spiral slot 13 and the measured gains of the UWB antenna with the spiral slot 13 according to the embodiment of the present invention in FIG. 9.

As illustrated in FIG. 9, the conventional TSA without the spiral slot 13 has constant and stable gains in the range of 1.9 to 5.4 dBi in the 3 to 11 GHz band. There is no significant difference between the gains of the UWB antenna with the spiral slot 13 according to the embodiment of the present invention and the gains of the conventional TSA without the spiral slot 13 in the 3 to 11 GHz band except for the notch band of 4.6 to 6.2 GHz.

Meanwhile, the UWB antenna with the spiral slot 13 according to the embodiment of the present invention exhibits a gain of about −9.5 dBi in the notch band of 4.6 to 6.2 GHz, unlike the conventional TSA without the spiral slot 13.

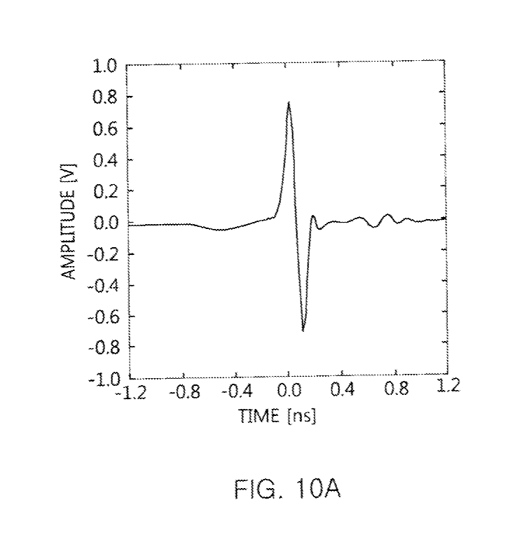

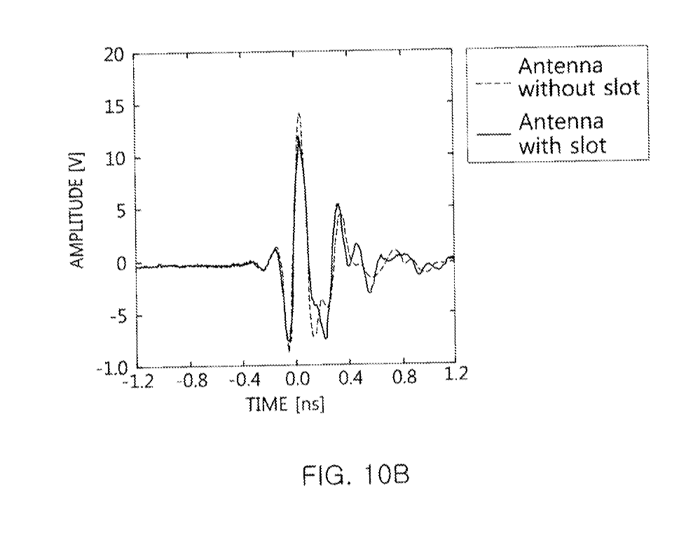

FIGS. 10A and 10B are graphs illustrating the impulse response characteristic of the UWB antenna having a frequency band notch function according to the embodiment of the present invention.

FIG. 10A is a graph illustrating an input waveform of the conventional TSA without the spiral slot 13 when the conventional TSA is used as a transmission antenna, and FIG. 10B is a graph illustrating the comparison between the measured impulse response characteristic of the conventional TSA without the spiral slot 13 and the impulse response characteristic of the UWB antenna with the spiral slot 13 according to the embodiment of the present invention. The waveforms of the received pulses were measured at an interval distance of about 1 m.

As illustrated in FIG. 10B, it can be seen that the UWB antenna having a frequency band notch function according to the embodiment of the present invention does not incur the distortion of the pulse because the received waveform of the UWB antenna having a frequency band notch function according to the embodiment of the present invention is similar to that of the conventional antenna, despite the presence of the spiral slot 13.

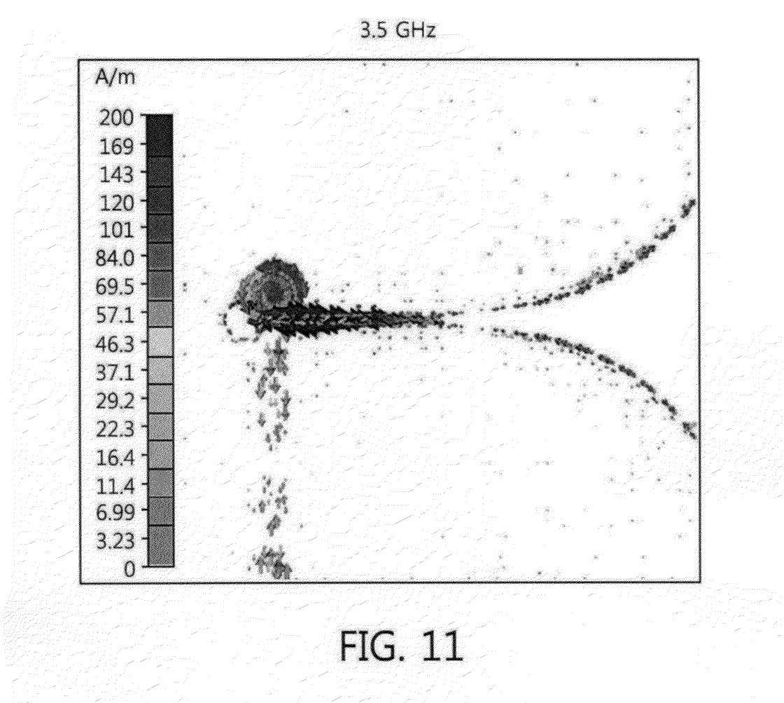

FIGS. 11 to 14 are current distribution simulation diagrams of the UWB antenna having a frequency band notch function according to the embodiment of the present invention.

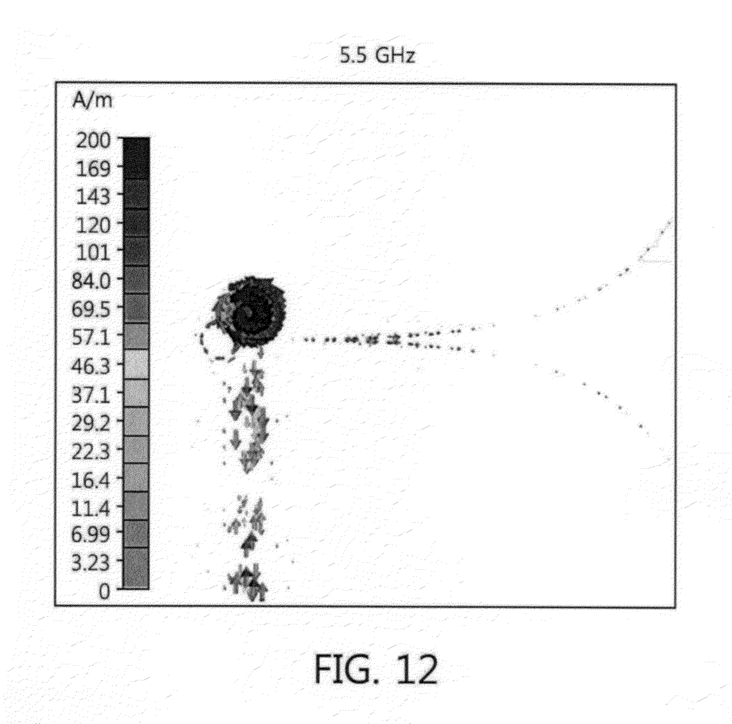

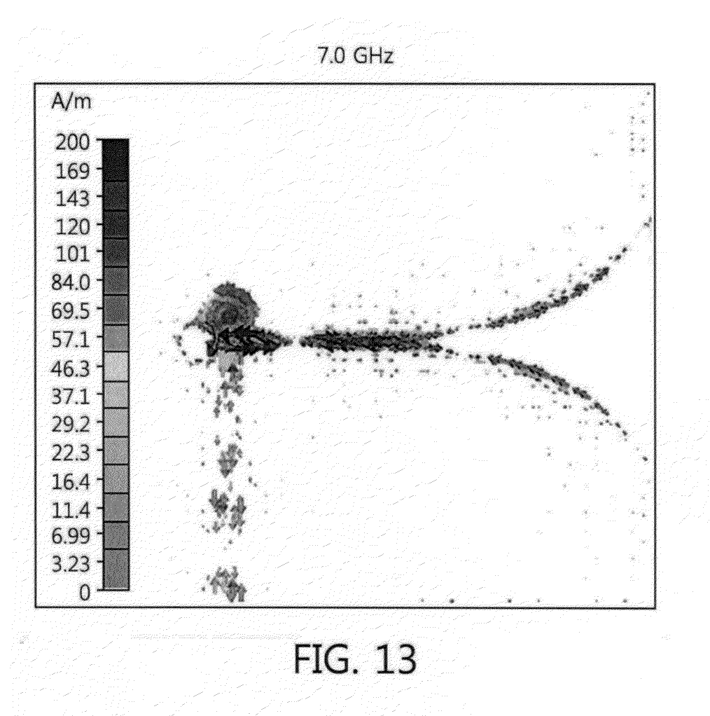

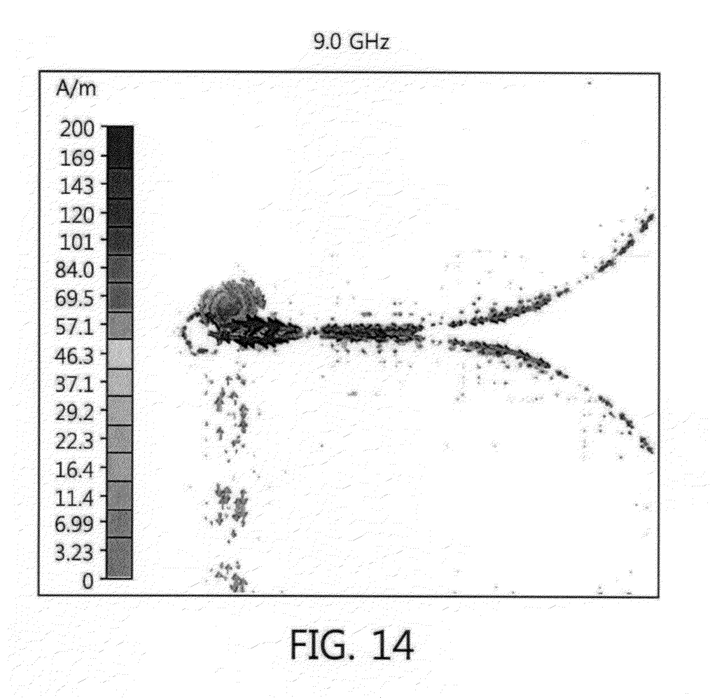

In greater detail, FIG. 11 is a current distribution simulation diagram of the UWB antenna having a frequency band notch function according to the embodiment of the present invention at a frequency of 3.5 GHz, FIG. 12 is a current distribution simulation diagram of the UWB antenna having a frequency band notch function according to the embodiment of the present invention at a frequency of 5.5 GHz, FIG. 13 is a current distribution simulation diagram of the UWB antenna having a frequency band notch function according to the embodiment of the present invention at a frequency of 7.0 GHz, and FIG. 14 is a current distribution simulation diagram of the UWB antenna having a frequency band notch function according to the embodiment of the present invention at a frequency of 9.0 GHz.

As illustrated in FIGS. 11, 13, and 14, it can be seen that when electric signals (for example, currents) at frequencies of 3.5 GHz, 7.0 GHz, and 9.0 GHz were applied, the electric signals at frequencies of 3.5 GHz, 7.0 GHz, and 9.0 GHz chiefly flowed alone the edges of the horn-shaped radiation part 20.

In contrast, as illustrated in FIG. 12, it can be seen that when an electric signal (for example, a current) at a frequency of 5.5 GHz was applied, a current distribution significantly increased in the spiral slot 13. This means that resonance occurs in the 5.5 GHz frequency band. Meanwhile, an electric signal at a frequency of 5.5 GHz is not radiated from the radiation part 20 and stored in the spiral slot 13.

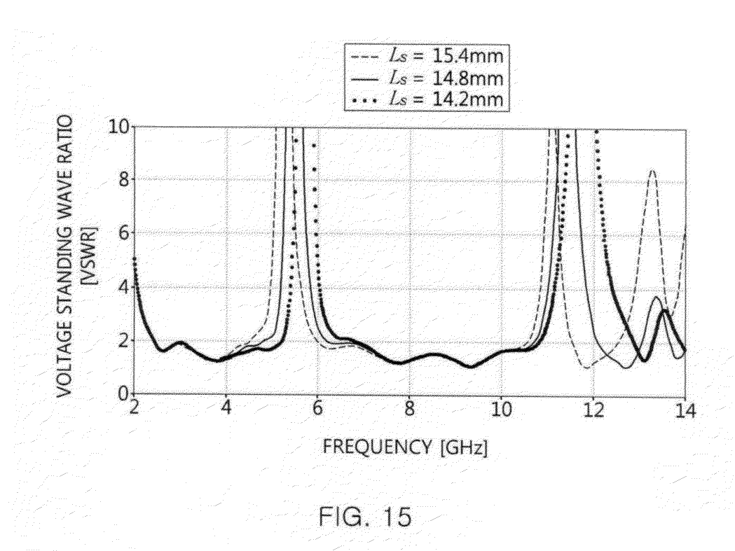

FIG. 15 is a graph illustrating the comparisons between VSWRs attributable to changes in the length of the spiral slot of the UWB antenna having a frequency band notch function according to the embodiment of the present invention.

In order to control the center frequency and bandwidth of the notch band, the VSWRs with respect to the parameter L_{S} illustrated in FIG. 1 were simulated. L_{S} is the length of the spiral slot 13.

As illustrated in FIG. 15, it can be seen that the center frequency of the notch band was lowered by increasing the length of the spiral slot 13.

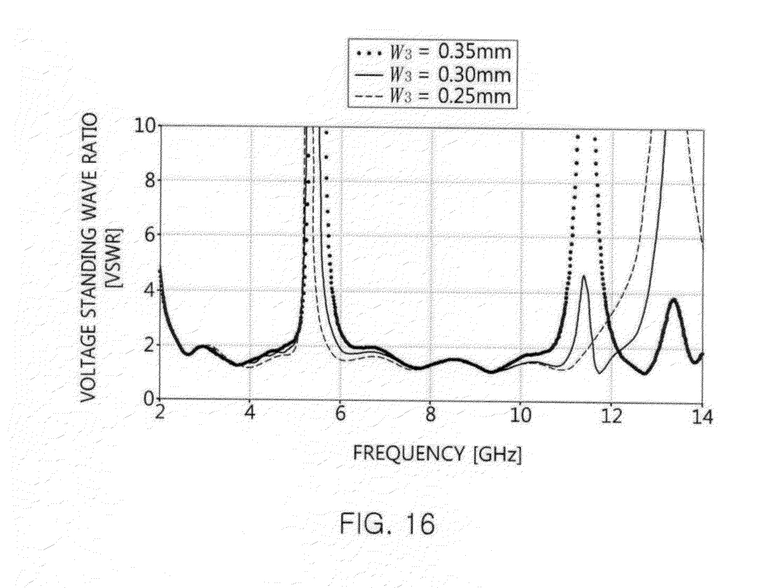

FIG. 16 is a graph illustrating the comparisons between voltage standing wave ratios attributable to changes in the width of the spiral slot of the UWB antenna having a frequency band notch function according to the embodiment of the present invention.

In order to adjust the bandwidth of the notch band, the voltage standing wave ratios with respect to the parameter W₃ illustrated in FIG. 1 were simulated. W₃ is the width of the spiral slot 13.

As illustrated in FIG. 16, it can be seen that the bandwidth of the notch band was decreased by reducing the width of the spiral slot 13.

The present invention is advantageous in that the UWB antenna having an omnidirectional gain suppression characteristic in the notch band can be implemented by simply forming a spiral slot corresponding to the notch frequency in the feeding part of an existing Vivaldi antenna.

Furthermore, the present invention is advantageous in that the present invention can be implemented such that a good time-domain performance can be achieved and in that the present invention can be implemented in a simple, small-sized, lightweight form so that the antennas of the present invention can be mass-produced at low cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An ultra-wideband (UWB) antenna having a frequency band notch function, comprising:
a substrate;
a radiation part formed on one surface of the substrate and configured to radiate radio signals;
a feeding part formed on the other surface of the substrate and configured to feed electric signals to the radiation part; and
a slot formed in a stub formed at one end of the feeding part and configured to reject signals in a notch band in the radio signals that are radiated by the radiation part.

2. The UWB antenna of claim 1, wherein the slot has a spiral shape.

3. The UWB antenna of claim 1, wherein the slot has a predetermined length and width.

4. The UWB antenna of claim 3, wherein a center frequency and bandwidth of the notch band are controlled by adjusting the length and width of the slot.

5. The UWB antenna of claim 3, wherein a center frequency of the notch band is lowered by increasing the length of the slot.

6. The UWB antenna of claim 3, wherein a bandwidth of the notch band is decreased by reducing the width of the slot.

7. The UWB antenna of claim 1, wherein the slot has a length corresponding to ½ of a wavelength of a center notch frequency.

8. The UWB antenna of claim 1, wherein the UWB antenna has an omnidirectional gain suppression characteristic in the notch band.

9. The UWB antenna of claim 1, wherein the radiation part has a tapered slot.

10. A UWB antenna having a frequency band notch function, comprising:
a dielectric substrate; and
a spiral shape slot formed at an end of a feeding line formed on one surface of the dielectric substrate opposite a radiation part formed on the other surface of the dielectric substrate, and configured to reject signals in a notch band in the radio signals that are radiated by the radiation part;
wherein the slot has a length corresponding to ½ of a wavelength of a center notch frequency.
